(19) United States
(12) Patent Application Publication
(10) Pub. No.: US 2013/0110853 A1
(43) Pub. Date: May 2, 2013

(54) SQL CONSTRUCTS PORTED TO NON-SQL DOMAINS

(71) Applicants: Burton Smith, Seattle, WA (US); Henricus Johannes Maria Meijer, Mercer Island, WA (US); David B. Wecker, Redmond, WA (US); Alexander Sasha Stojanovic, Los Gatos, CA (US); Michael Isard, San Francisco, CA (US); Savas Parastatidis, Seattle, WA (US)

(72) Inventors: Burton Smith, Seattle, WA (US); Henricus Johannes Maria Meijer, Mercer Island, WA (US); David B. Wecker, Redmond, WA (US); Alexander Sasha Stojanovic, Los Gatos, CA (US); Michael Isard, San Francisco, CA (US); Savas Parastatidis, Seattle, WA (US)

(73) Assignee: MICROSOFT CORPORATION, Redmond, WA (US)

(21) Appl. No.: 13/286,152

(22) Filed: Oct. 31, 2011

(51) Int. Cl. G06F 17/30

(52) U.S. Cl. 707/756; 707/E17.014; 707/E17.005

(57) ABSTRACT

The subject disclosure relates to using structured query language constructs in non-structured query language domains. For example, through mathematical and logical transformation of concepts from a key, value pair domain associated with structured query language data structures to graphical-related data structures, the value originating in the structured query language domain can be modified for use in non-structured query language domains. This can open up options in analytics and can solve some of the problems associated with liner algebra.

### TECHNICAL FIELD

The subject disclosure generally relates to Structured Query Language (SQL) data constructs and porting the SQL data constructs to non-SQL domains based on an analysis of the SQL data constructs and results to achieve with respect to the SQL data constructs.

### BACKGROUND

As computing technology advances and computing devices become more prevalent, the usage of computers for daily activities has become commonplace. For example, a person might utilize a web browser or another search application to obtain information related to a wide variety of topics. In a specific example, a search might be conducted while driving in order to locate a nearest filling station. In order to return search results, the computing device searches a vast amount of data related to a current location and filling stations near the current location. As can be imagined, the data to be accessed and reviewed to obtain the requested information can be quite a large amount of data.

Various search tools have been develop to allow for efficiency in finding items of interest and/or manipulating (or working with) the items of interest. Such search tools can be employed for various sizes of datasets. However, when the datasets grow very large, working with the dataset(s) can become awkward or difficult to manage. These very large datasets are referred to as “big data”. The awkwardness of big data includes difficulty capturing the data, storing the data, searching through the data, sharing the data, performing analytics (or problem solving) with the data, visualizing the data, as well as other difficulties.

For example, a difficultly associated with big data is working with relational databases. A relational database operates to match data by using common characteristics within the dataset. The resulting groups of data can be organized in a manner that is logical and easier for a person to understand. In an example, SQL (Structured Query Language) is a specialized language that can be utilize to update, delete, and/or request information from databases. A variety of SQL constructs have been developed for efficient operations over SQL data structures. These SQL constructs can be ported to other non-SQL domains, including big data.

However, there are some constraints related to the SQL constructs. For example, when the SQL constructs are being designed or developed, the development is directed to a particular domain view (e.g., a table). Therefore, if the SQL construct is to be updated or modified, such actions are performed in the particular domain view in which the SQL construct was designed.

The above-described deficiencies of today's computing system and SQL constructs are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

Aspects disclosed herein relate to facilitating the use of SQL constructs in non-SQL domains. According to various aspects, provided is a means of porting SQL constructs to non-SQL constructs, such as graphs, as a focal data structure instead of key-value pairs (e.g., a data representation in computing systems and applications). The disclosed aspects also provide a mathematical and logical transformation of key-value pair to graphical-related data structures.

These and other embodiments are described in more detail below.

### BRIEF DESCRIPTION OF THE DRAWINGS

Various non-limiting embodiments are further described with reference to the accompanying drawings in which:

FIG. 1 illustrates a block diagram of an exemplary computing system, according to an aspect;

FIG. 2 illustrates an exemplary non-limiting system configured to port structured query language constructs to non-structured query language domains, according to an aspect;

FIG. 3 illustrates data represented in a table space, according to an aspect;

FIG. 4 illustrates an exemplary tensor, according to an aspect;

FIG. 5 illustrates an exemplary two-dimensional rank-two tensor;

FIG. 6 illustrates an exemplary two-dimensional rank-three tensor;

FIG. 7 illustrates an exemplary hypergraph;

FIG. 8 illustrates an exemplary hypergraph representation for the same data as discussed above;

FIG. 9 illustrates a non-limiting exemplary system for structured query language constructs ported to non-structured query language domains, according to an aspect;

FIG. 10 illustrates a non-limiting flow diagram of using structured query language constructs in a non-structured query language domain, according to an aspect;

FIG. 11 illustrates another non-limiting flow diagram of using structured query language constructs in a non-structured query language domain, according to an aspect;

FIG. 12 is a block diagram representing exemplary non-limiting networked environments in which various embodiments described herein can be implemented; and

FIG. 13 is a block diagram representing an exemplary non-limiting computing system or operating environment in which one or more aspects of various embodiments described herein can be implemented.

### DETAILED DESCRIPTION

### Overview

With the ubiquitous use of the Internet and related technologies, a tremendous amount of data is available for consumption in various formats. One such format is defined as Structured Query Language (SQL) constructs (e.g., basic elements, commands, and statements). SQL is a programming language (or declarative computer language) that is used to manage data in relational database management systems (RDBMS). The scope of SQL includes data insert, query, update and delete, and data access control, as well as others. Generally, the RDBMS includes data stored in tables and relationships between the tables are also stored in tables.

The amount of data in storage has grown exponentially, and, in some cases, SQL-style tables might no longer be capable of storing the data and executing queries. Further, in some cases, the SQL-style tables might not be the most advantageous manner of storing the data and executing the queries. However, there is a large amount of data already retained in the SQL-style tables and extracting the data to another format might prove difficult or expensive for the already captured data.

In addition, some programmers are skilled in creating SQL constructs and, therefore, perform their respective programming functions by composing, manipulating, and executing SQL queries. However, other programmer might not utilize SQL queries and, therefore, the SQL query syntax might be unfamiliar to these other programmers. Thus, these other programmers will most likely not utilize SQL query syntax but will perform their respective functions using a different construct. This creates a disconnect with the data retained in the SQL-style tables and the data stored in the different construct. In order to make the data compatible (e.g., to change an underlying data store implementation), there is added time and expense involved. For example, a programmer will need to learn the different programming language or data retained in one format will need to be reentered in the other format.

Thus, it would be beneficial to provide a means of facilitating use of SQL constructs in non-SQL domains. In an aspect, such use of SQL constructs can be hidden from the programmer. For example, the programmer might enter data in one format (e.g., SQL) and, based on how that data is to be used, the data might be stored or manipulated in a different format, such as a table, a matrix, a tensor, a graph, a hypergraph, and so forth.

An aspect relates to a system, comprising a data access component configured to obtain data represented in a first format and an abstraction component configured to transform a representation of the data from the first format to a second format based on a defined end result of the data. The data in the first format is defined in a structured query language construct and the representation of the data in the second format is in a non-structured query language domain. In an example, the abstraction component is further configured to hide from a user details related to the transform and the second format.

In an example, the data access component is configured to obtain the data in an input data format and a processing component is configured to transform the representation of the data from the input data format to a storage format. The storage format is independent of the input data format.

In another example, the system comprises a query enhancement component configured to analyze the defined end result and determine a suitable format type for the representation of the data, wherein the suitable format type is determined based on efficiency or ease of implementation. According to another example, the system comprises a conversion component configured to change a data representation to be compatible with another data representation. In a further example, the system comprises a storage component configured to retain the representation of the data in a third format that is independent of the first format and the second format.

According to some examples, the second format is one of a table, a matrix, a tuple, a graph, or a hypergraph. In an aspect, the first format and the second format are different representations of the same data.

In an aspect, the system includes an interface component configured to receive a request for the data. Further to this aspect, the abstraction component obtains the data in a storage format and transforms the data from the storage format to a format that corresponds to the received request. In an example, the abstraction component is further configured to utilize structured query language constructs in non-structured query language domains.

According to another aspect is a method, comprising obtaining data in a structured query language format and interpreting a representation of the data. The method also includes transforming the representation of the data from the structured query language format to a non-structured query language format, wherein the non-structured query language format provides an efficiency function or a simplicity function. The method also includes outputting the data in the non-structured query language format. The outputted data can be perceived by a user, such as a programmer.

In an example, obtaining the data comprises accessing the data from a storage media. In another example, interpreting the representation of the data comprises receiving an explicit definition of a desired result. Further to this example, the transforming is a result of the explicit definition. In another example, interpreting the representation of the data comprises inferring a definition of a desired result as a function of one or more data inputs. Further to this example, the transforming is based on the inferred definition.

According to an example, the structured query language format and the non-structured query language format provide equivalent results. In some aspects, the method includes storing the data in a structured query language format or a non-structured query language format. In another example, obtaining the data comprises receiving a request for the data.

A further aspect relates to a computer-readable storage medium comprising computer-executable instructions stored therein that, in response to execution, cause a computing system to perform operations. The operations performed comprise gathering data represented in a first format and transforming, in real-time, a representation of the data from the first format to a second format. The transforming can be based on a defined end result of the data. The data in the first format is defined in a structured query language construct and the representation of the data in the second format is in a non-structured query language domain. The second format is selected based on an efficiency in obtaining the defined end result.

In an example, the operations performed further comprise hiding details of the transforming from one or more users (or programmers). According to another example, the first format and the second format are different representations of the same data.

Herein, an overview of some of the embodiments for porting SQL constructs to non-SQL domains has been presented above. As a roadmap for what follows next, various exemplary, non-limiting embodiments and features for transformation of data are described in more detail. Then, some non-limiting implementations and examples are given for additional illustration, followed by representative network and computing environments in which such embodiments and/or features can be implemented.

### SQL Constructs Ported to Non-SQL Domains

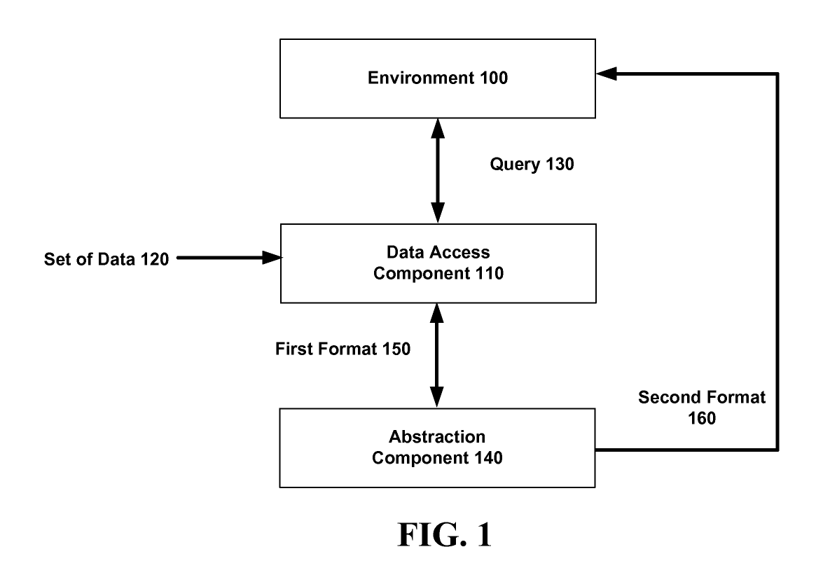

By way of further description with respect to one or more non-limiting ways to provide porting of SQL constructs to non-SQL domains, including Big Data, a block diagram of an exemplary computing system is illustrated generally by FIG. 1. The various aspects disclosed herein can be utilized for data services, or any combination of the runtime and web service through which the services are exposed. Further, “porting” refers to the process of adapting software so an executable program can be created.

The exemplary computing system allows for abstraction and manipulation of representations of data, wherein details related to the composition, storage, manipulation and execution of the data is hidden from the programmer (or user).

The computing system illustrated in FIG. 1 includes an environment 100, which can be a programming environment. However, the disclosed aspects are not so limited and the environment 100 can be an execution environment (e.g., execution of a query), a user environment (e.g., a request for search results that are returned as a list or in another format such as when a non-programmer or individual requests an Internet search), or another type of environment. In some aspects, the environment 100 is associated with one or more personal devices, such as mobile devices, where each of the personal devices can be associated with different users. In other aspects, the environment 100 is associated with a distributed network and personal devices are configured to operate based on operation parameters of the distributed network. For example, a business can provide computing capabilities over a distributed network for use with personal devices (e.g., cell phone, laptop, PDA (Personal Digital Assistant), and so forth). However, other types of environments can also be suitable for use with the disclosed aspects.

Also included in computing system is a data access component 110 configured to obtain a set of data 120. For example, a query 130 can be received from the environment 100. Based on the query 130, data access component 110 is configured to obtain the set of data 120. For example, the query can be a request for information related to refinishing a wood floor that is input as a query, which can be represented by a word (e.g., “refinish”), a pair of words (e.g., “wood floor”), a phase (e.g., “refinish a wood floor”), a question (e.g., “How do I refinish my hard wood floor”?), or in another manner. Further, the query can be received in human language format or computer-language format. In an example, the means of entering the query can be a search engine, such as a Web search engine that is designed to search the World Wide Web and FTP servers for information. In some applications, the search can be conducted by accessing databases and/or open directories, for example. The results of a search based on the query can be presented as a list and can include data in various formats (e.g., web pages, images, data, as well as files).

In some aspects, the query 130 is related to performing modifications and/or other actions on the underlying data constructs. For example, a programmer might make changes to how search results are found and presented. In this case, the set of data 120 retrieved would be the underlying data constructs.

In some aspects, the set of data 120 can be represented in a first format. In a simple example, the set of data (or result) is the number five, which can be represented in a multitude of formats such as, for example:

A word:
“FIVE” “Five” “five”

A decimal:
“5” “5.0”

A Roman numeral:
V

As tally marks or hash marks:

[symbol]

In binary format:
101

As illustrated above, the number 5 can be expressed or represented in various formats (including other formats not listed above). Although expressed differently, each form of expression is a valid representation of the same data, in this example, the number 5. In different situations, one of the representations might be in an improved format than other representations. For example, for a simple addition function, the tally or hash marks might be easier to manipulate. However, if the result (e.g., 5) is for use with digital electronic circuitry, the representation might be expressed in binary format. If the result is for use in a letter, the word “five” might be the appropriate representation for use within the letter.

To facilitate representation of the search result in a proper format, an abstraction component 140 configured to transform a representation of the data from the first format 150 to a second format 160 based on a defined end result of the data.

The abstraction component 140 is configured to perform the transformation in real-time (e.g., at substantially the same time as the request is received, with minimal delay, and so forth). In some aspect, the transformation is performed based on an efficiency in obtaining the defined end result.

Continuing the above example, if the number 5 is retained as text “five” but the result is to be used for mathematical equations, abstraction component 140 can retrieve the result in its first format (e.g., “five”) and convert the representation of the data from “five” to, for example, “5.0”. In such a manner, the representation of the search result (or data) is returned (e.g., to the environment 100) in a useful format.

In some aspects, the abstraction component 140 is configured to receive an explicit definition of what is desired. For example, the query can include the format that is desired (e.g., “find me the result in decimal format”). Thus, the programmer or user can specify the format. In other aspects, the abstraction component 140 is configured to receive the definition of what is desired implicitly based on user preferences, previous search parameters or criteria, applications executing within the environment 100 and so forth. In some aspects, the abstraction component 140 (or another component) interfaces with the programmer to receive further instructions through a question/answer format or another means of conveying information.

As discussed herein, the disclosed aspects can utilize mathematical and logical transformation of concepts from a key, value pair domain associated with SQL data structures to graphical-related data structures (e.g., unifying tables, sparse matrixes, tensors, graphs, hypergraphs, and so forth). Much of the innovation value that originates in the SQL domain can be modified for use in non-SQL domains, including applications to big data. For example, in an embodiment, a hypergraph with 3 endpoints per edge can be implemented for key value (aᵢⱼ) pairs, and a table can be built to assist with the transformation. Hypergraph edges can represent joins and higher and higher power can be computed off these edges. Other operations can include: Join aⱼₖ with aᵢⱼ—quintuples, multiple joins to perform a sum reduction over J, projections of triples, as well as others. Various embodiments include implementations using hyperedges, edges, tables, and so forth.

In an embodiment, the computing system illustrated by FIG. 1 can differ in operation from conventional computing systems in order to provide additional benefits over those achievable by computing systems that employ conventional SQL domains. For instance, the computing system disclosed herein can utilize SQL constructions in non-SQL domains. For example, a layer can hide the details regarding whether the computer executes equivalent functions but with different domain views.

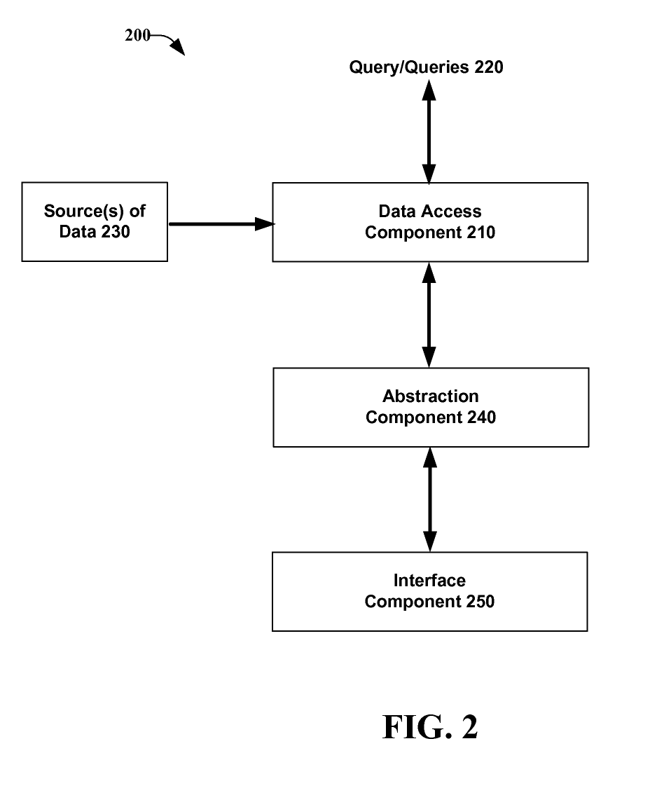

FIG. 2 illustrates an exemplary non-limiting system 200 configured to port structured query language constructs to non-structured query language domains, according to an aspect. Included in system 200 is a data access component 210 configured to receive one or more queries 220. For example, a query can be received from a user and can be input as a search request or a request for underlying data constructs (e.g., from a programmer). The data access component 210 is configured to retrieve the requested data from one or more sources of data 230, wherein the requested data can be stored in different domain views, including, but not limited to, a table, a matrix, and a graph. In an example, the sources of data 230 can be a single source of data or can be two or more sources of data. In the case where the data is retrieved from two or more sources of data, the data can be represented in each source in a different domain (e.g., data in first source is represented as a table and data in a second source is represented as a graph).

Based on the retrieved data, an abstraction component 240 is configured to manipulate or transform the retrieved data while hiding the details of the transformation from a programmer or user. For example, abstraction component 240 can be a layer that hides the details regarding whether the computer or system 200 performs equivalent functions, but with different domain views (e.g., table, matrix, graph, and so forth).

For example, a programmer might need to update an underlying data store implementation of a network, such as a social network. The programmer can request the underlying data and might implicitly or explicitly request the data in a particular format. Thus, regardless of how the data is stored, abstraction component 240 is configured to manipulate or transform the representation of the data into the requested format, regardless of the format in which the representation the data is stored.

Abstraction component 240 provides the representation of data to the user through an interface component 250 that presents the data to the programmer in the appropriate domain. The interface component 250 can provide a graphical user interface (GUI), a command line interface, a speech interface, Natural Language text interface, and the like. For example, a GUI can be rendered that provides a user with a region or means to load, import, select, read, and so forth, various requests and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The user can also interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed aspects are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

The programmer can make changes to the data and request that the changes be saved, such request can be entered by the programmer through the interface component 250. The abstraction component 240 is configured to transform the updated data to a different domain (or different representation of the data), as appropriate. For example, if the data was updated by the programmer (and the updated data) received in the form of a graph, the abstraction component 240 might make a determination that the data is to be stored in a different domain (e.g., table format). Thus, the abstraction component 240 can transform the data to the different domain, where such transformation is hidden from the programmer. When the programmer is to make additional changes and/or updates, the programmer requests the data, which is presented in the appropriate domain, without the programmer knowing that the data was stored in a different domain.

By way of example, and not limitation, the following will discuss various domains that can be utilized with the disclosed aspects. It is to be understood that this discussion is for purposes of explanation and different or additional domains than those discussed herein can be utilized with the one or more aspects disclosed herein.

FIG. 3 illustrates data represented in a table space 300, according to an aspect. As illustrated the table space 300 can be represented as a set of tuples, such as 3 tuples, where a tuple is an ordered set of elements. The example table space 300 includes four rows 302, 304, 306, and 308 and three columns 310, 312, and 314. The example table 300 provides information regarding the relationship between “1”, “2”, “3”, “4”, and so on. Tables are well known to those of skill in the art and so will not be further described herein. However, a table is not the only domain that can be utilized to provide the relationship information.

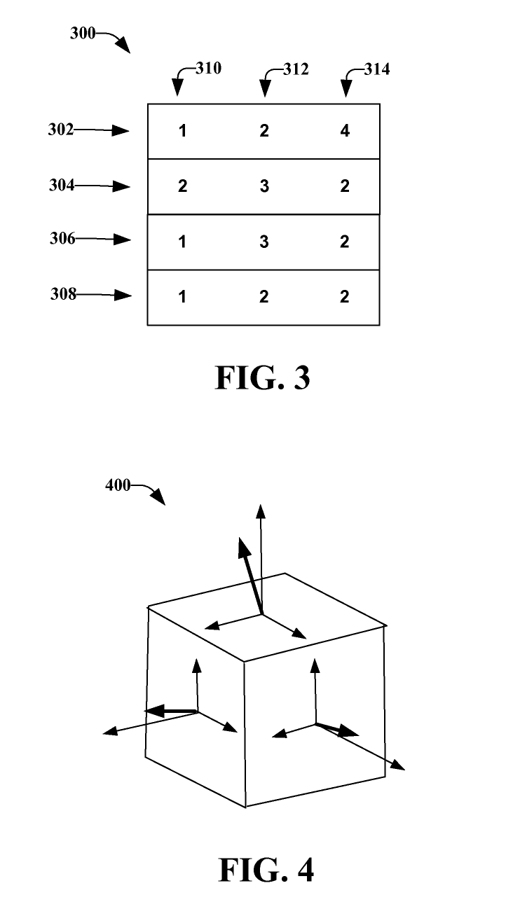

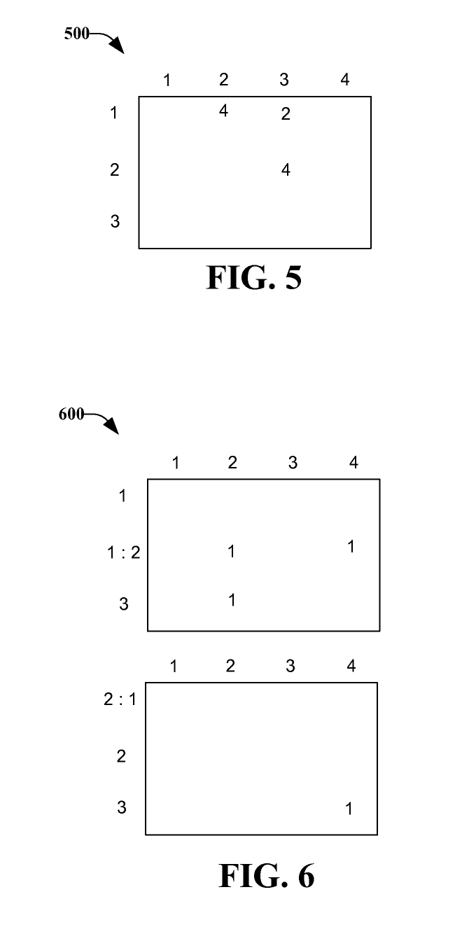

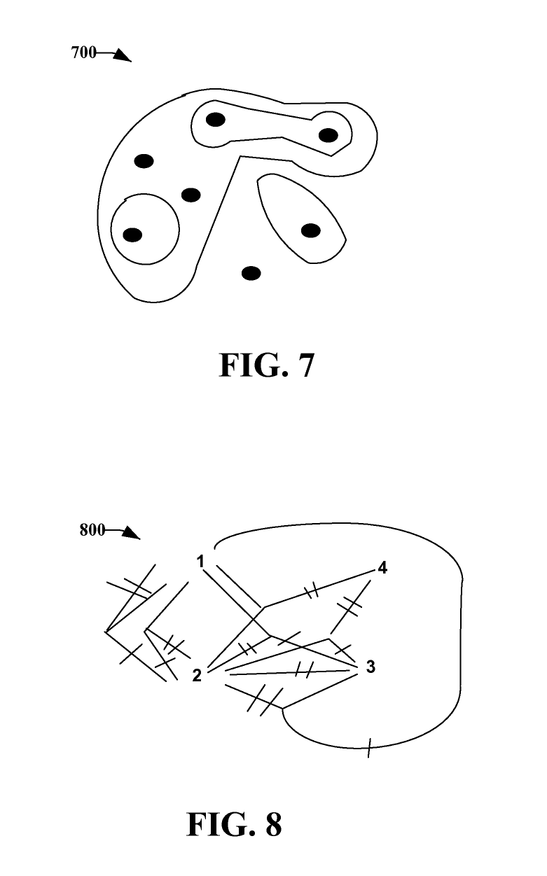

FIG. 4 illustrates an exemplary tensor 400, according to an aspect. A tensor is a generalized matrix and can have more than two dimensions. The tensor can be represented as a multi-dimensional array of numerical values and is a geometric object that describes linear relations between vectors, scalar, and other tensors. The components of the tensor, in a three-dimensional Cartesian coordinate system, form a matrix. The exemplary tensor 400 is a second-order (or rank-two) tensor. Tensors are well known to those of skill in the art and so will not be further described herein. Instead, to provide further context, FIG. 5 illustrates an exemplary two-dimensional rank-two tensor 500. As shown, “1” and “2” map to “4”; “2” and “3” map to “4”; and “1” and “3” map to “2”. FIG. 6 illustrates an exemplary two-dimensional rank-three tensor 602. Multiples of the same duplicates can be represented by increasing the count of the set.

FIG. 7 illustrates an exemplary hypergraph 700. A hypergraph is a generalization of a graph, where an edge can connect any number of vertices. Hyperedges are an arbitrary set of nodes (represented by the filled circles) and can contain an arbitrary number of nodes. FIG. 8 illustrates an exemplary hypergraph representation 800 for the same data as discussed above. Illustrates are nodes 1, 2, 3, and 4. As shown, a hyperedge can more than two endpoints (e.g., 3, 4, 5, and so on). As illustrated by the above figures, a table, a tensor, and a hypergraph can de different representations for the same data, wherein the disclosed aspects can be configured to transform between the representations while hiding the detail regarding the representations from the programmer. For example, a matrix multiply can be a table join. In another example, a tensor multiply can be a join also. Thus, a table with three columns can be transformed into a rank-3 tensor, for example. Therefore, the disclosed aspects can change the representation of the same data and the operation can be changed automatically in order to produce the same result. In some situations a tensor might be utilized while in other situations a table might be utilized for certain operations (or based on preferences of the programmer). The selection can be based on an efficiency function or a simplicity function.

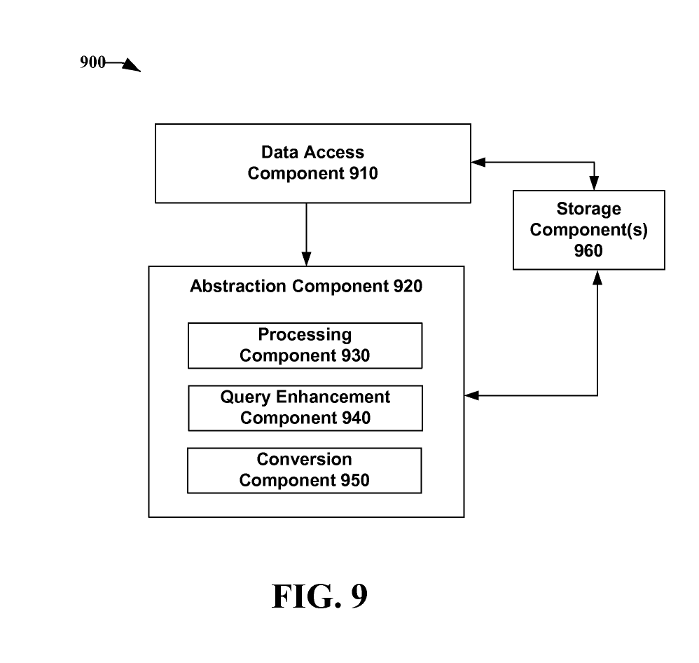

FIG. 9 illustrates a non-limiting exemplary system 900 for SQL constructs ported to non-SQL domains, according to an aspect. As discussed, sometimes a big data problem is more adequately represented in one form rather than other forms or representations. Further, a program can be written in one or the other representation however, manipulation of the program might occur in a different representation. Thus, the disclosed aspects can provide a programming model that allows the data to be represented in a single way but can be viewed in different representations, independent of how the data is to be represented.

The exemplary system 900 comprises a data access component 910 configured to obtain a set of data represented in a first format and an abstraction component 920 configured to transform a representation of the data from the first format to a second format. For example, the first set of data can be defined in a structured query language construct and the data in the second format can be represented in a non-structured query language domain. In accordance with some aspects, the abstraction component 920 is further configured to hide details related to the transform and the second format from a programmer or other user. The second format can be one of a table, a matrix, a tuple, a graph, or a hypergraph. In an aspect, the first format and the second format are different representations of the same data.

According to an aspect, the abstraction component 920 is further configured to utilize structured query language constructs in non-structured query language domains. In some aspects, the abstraction component 920 comprises a processing component 930. If the data is being provided as new data, the data access component 910 is configured to obtain the set of data as input data and the processing component 930 is configured to transform the representation of the data from the input data format to a storage format. The storage format can be independent of the input data format.

The transformation by abstraction component 920 can be based on a defined end result of the data (e.g., based on how the data will be used; based on preferences of the programmer; and so forth). For example, a query enhancement component 940 can be configured to analyze the defined end result and determine a suitable format type for the representation of the data. For example, the suitable format type can be determined based on efficiency or ease of implementation. In accordance with some aspects, the query enhancement component 940 utilizes historical information related to the data and what actions were performed with the data. In another aspect, the historical information is user preference data.

In accordance with some aspects, a conversion component 950 is configured to change a data representation to be compatible with another data representation. For example, in order to perform programming, data from two or more sources might be needed. However, the data in the two or more source might not be represented in the same manner (e.g., one set of data might be represented as a tuple and another set of data might be expressed as a hypergraph). Conversion component 950 is configured to analyze the data from each source and automatically convert or transform the data from at least one of the sources to be compatible with the other source. Further, the data might be output to the programmer in a different format (e.g., as a table).

System 900 can also include a storage component 960 configured to retain the representation of the data in a third format that is independent of the first format and the second format. However, the disclosed aspects are not so limited and the storage component 960 can be configured to retain the representation of the data in the first format, the second format, or another format. Further, the data access component 910 is configured to access the storage component 960 to retrieve the requested data. In some aspects, more than one storage component 960 is accessed by data access component 910 to retrieve the data and/or abstraction component 920 to save the data.

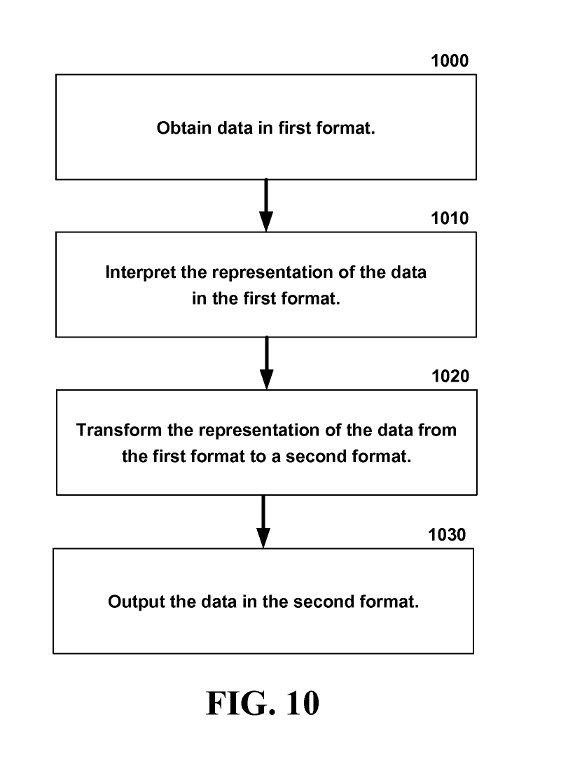

FIG. 10 illustrates a non-limiting flow diagram of using SQL constructs in a non-SQL domain, according to an aspect. At 1000, data is obtained in a first format. For example, the first format can be a first representation of the data, which can be represented in a variety of different manners, such as in a SQL domain.

At 1010, the representation of the data is interpreted. Such interpretation can be related to how the data will be used, the structure of the other data or how the other data is represented, as well as other criteria (e.g., preferences, simplicity of implementation, and so forth).

The representation of the data is transformed, at 1020, from the first format to the second format. The transformation can be a function of the original representation of the data (e.g., first format) and the interpretation. At 1030, the data is output in the second format. Outputting the data can include displaying the data on a user interface, for example. In another example, the first format is in an SQL domain and the second format is in a non-SQL domain.

In accordance with some aspects, the first format is a structured query language format and the second format is a non-structured query language format. Further to this aspect, the non-structured query language format provides an efficiency function or a simplicity function and the non-structured query language format provides efficiency or ease of implementation.

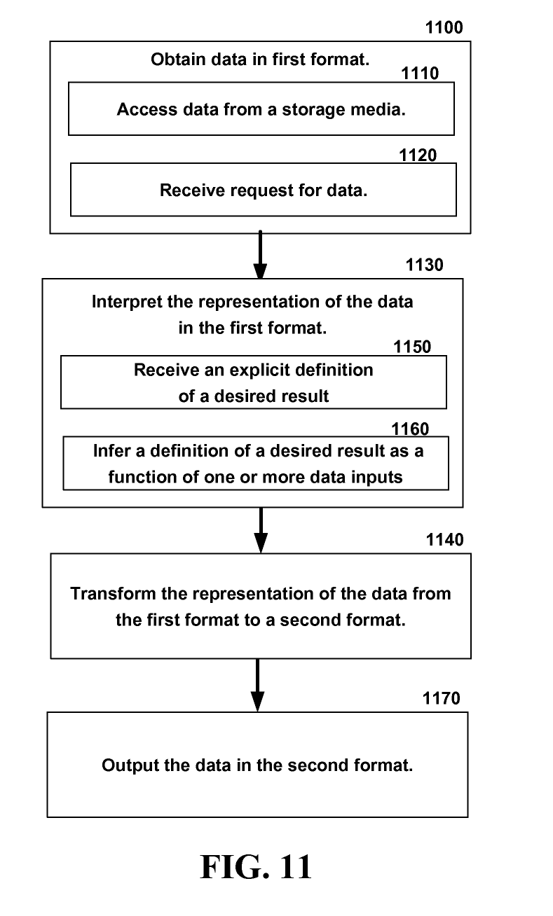

FIG. 11 illustrates another non-limiting flow diagram of using SQL constructs in a non-SQL domain, according to an aspect. At 1100, data, represented in a first format, is obtained. For example, the data can be obtained based on a user input (e.g., data is created). In an example, obtaining the data includes accessing the data from a storage media, at 1110. Alternatively or additionally, obtaining the data can include receiving a request for the data, at 1120, where the data is retrieved from a storage media.

At 1130, the representation of the data is interpreted and, at 1140, the representation of the data is transformed from the first format to the second format. The first format and the second formats provide equivalent results. For example, the interpretation can include receiving an explicit definition of a desired result, at 1150, and the transforming is a result of the explicit definition. Alternatively or additionally, the interpretation includes inferring a definition of a desired result as a function of one or more data inputs, at 1160, and the transforming is based on the inferred definition. At 1170, the data is output in the second format. Outputting the data can include displaying the data (or underlying constructs) on a display. In some aspects, the data is stored in a third format.

As discussed, the disclosed aspects facilitate the use of SQL constructs in non-SQL domains, such as graphs, as a focal data structure, or other formats. The various aspects are configured to hide details related to whether equivalent functions can be performed with different domain views (e.g., table, matrix, graph). In an example, if looking at numbers that are to be multiplied together, a mix of different representations of the numbers (e.g., hash marks and Roman numbers) are not compatible, therefore, a similar representation is selected and, as needed, the numbers are transformed to the similar representation. The details of the transform are hidden from the programmer, wherein the programmer might hard code data in a particular manner and is not aware that a different manner of representing the data is equivalent. Thus, the programmer is not concerned with the representation and can use any of the abstractions, as appropriate.

### Exemplary Networked and Distributed Environments

One of ordinary skill in the art can appreciate that the various embodiments of the SQL construct to non-SQL domain systems and methods described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects, or resources that may participate in the access control and execution mechanisms as described for various embodiments of the subject disclosure.

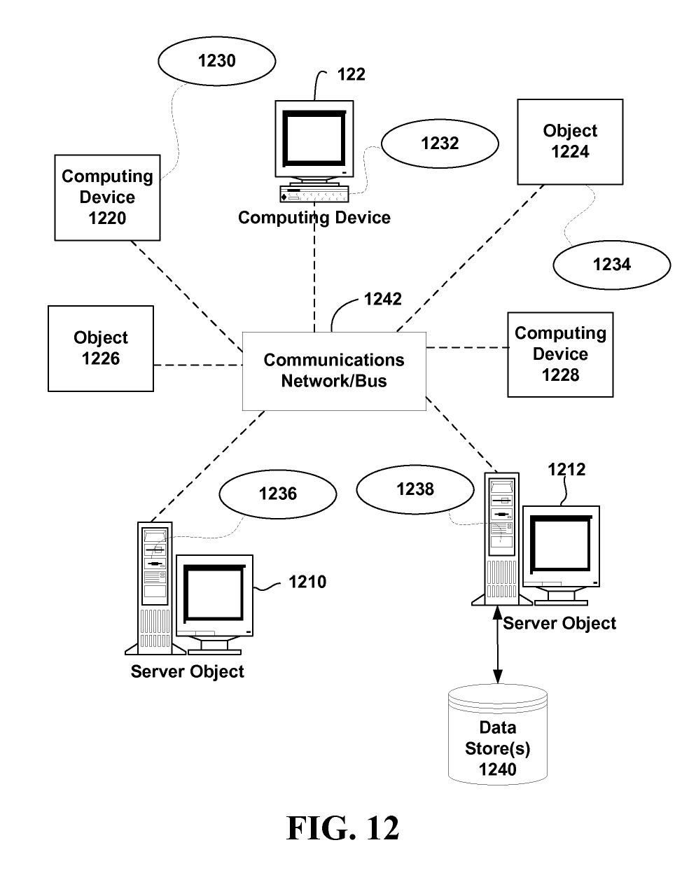

FIG. 12 provides a schematic diagram of an exemplary networked or distributed computing environment. The distributed computing environment comprises computing objects 1210, 1212, etc. and computing objects or devices 1220, 1222, 1224, 1226, 1228, etc., which may include programs, methods, data stores, programmable logic, etc., as represented by applications 1230, 1232, 1234, 1236, 1238 and data store(s) 1240. It can be appreciated that Computing objects 1210, 1212, etc. and computing objects or devices 1220, 1222, 1224, 1226, 1228, etc. may comprise different devices, such as personal digital assistants (PDAs), audio/video devices, mobile phones, MP3 players, personal computers, laptops, etc.

Each computing object 1210, 1212, etc. and computing objects or devices 1220, 1222, 1224, 1226, 1228, etc. can communicate with one or more other computing objects 1210, 1212, etc. and computing objects or devices 1220, 1222, 1224, 1226, 1228, etc. by way of the communications network 1242, either directly or indirectly. Even though illustrated as a single element in FIG. 12, communications network 1242 may comprise other computing objects and computing devices that provide services to the system of FIG. 12, and/or may represent multiple interconnected networks, which are not shown. Each computing object 1210, 1212, etc. or computing object or devices 1220, 1222, 1224, 1226, 1228, etc. can also contain an application, such as applications 1230, 1232, 1234, 1236, 1238, that might make use of an API, or other object, software, firmware and/or hardware, suitable for communication with or implementation of the access control and management techniques provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, although any network infrastructure can be used for exemplary communications made incident to the access control management systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 12, as a non-limiting example, computing objects or devices 1220, 1222, 1224, 1226, 1228, etc. can be thought of as clients and computing objects 1210, 1212, etc. can be thought of as servers where computing objects 1210, 1212, etc., acting as servers provide data services, such as receiving data from client computing objects or devices 1220, 1222, 1224, 1226, 1228, etc., storing of data, processing of data, transmitting data to client computing objects or devices 1220, 1222, 1224, 1226, 1228, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1242 or bus is the Internet, for example, the computing objects 1210, 1212, etc. can be Web servers with which other computing objects or devices 1220, 1222, 1224, 1226, 1228, etc. communicate via any of a number of known protocols, such as the hypertext transfer protocol (HTTP). Computing objects 1210, 1212, etc. acting as servers may also serve as clients, e.g., computing objects or devices 1220, 1222, 1224, 1226, 1228, etc., as may be characteristic of a distributed computing environment.

### Exemplary Computing Device

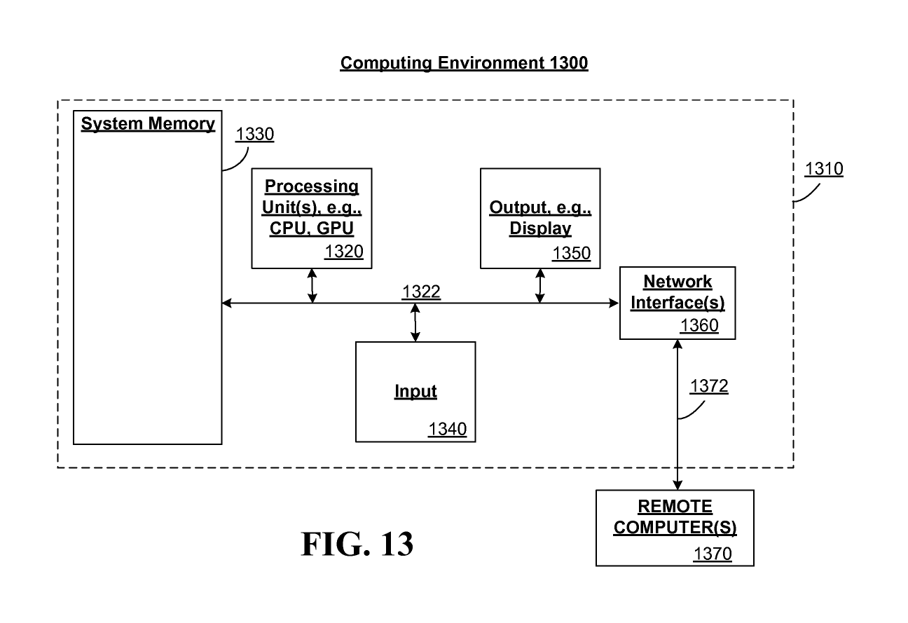

As mentioned, advantageously, the techniques described herein can be applied to any device where it is desirable to perform transformation of SQL constructs to a non-SQL domain in a computing system. It can be understood, therefore, that handheld, portable and other computing devices and computing objects of all kinds are contemplated for use in connection with the various embodiments, i.e., anywhere that resource usage of a device may be desirably enhanced. Accordingly, the below general purpose remote computer described below in FIG. 13 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 13 thus illustrates an example of a suitable computing system environment 1300 in which one or aspects of the embodiments described herein can be implemented, although as made clear above, the computing system environment 1300 is only one example of a suitable computing environment and is not intended to suggest any limitation as to scope of use or functionality. Neither should the computing system environment 1300 be interpreted as having any dependency or requirement relating to any one or combination of components illustrated in the exemplary computing system environment 1300.

With reference to FIG. 13, an exemplary remote device for implementing one or more embodiments includes a general purpose computing device in the form of a computer 1310. Components of computer 1310 may include, but are not limited to, a processing unit 1320, a system memory 1330, and a system bus 1322 that couples various system components including the system memory to the processing unit 1320.

Computer 1310 typically includes a variety of computer readable media and can be any available media that can be accessed by computer 1310. The system memory 1330 may include computer storage media. Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

A user can enter commands and information into the computer 1310 through input devices 1340. A monitor or other type of display device is also connected to the system bus 1322 via an interface, such as output interface 1350. In addition to a monitor, computers can also include other peripheral output devices such as speakers and a printer, which may be connected through output interface 1350.

The computer 1310 may operate in a networked or distributed environment using logical connections, such as network interfaces 1360, to one or more other remote computers, such as remote computer 1370. The remote computer 1370 may be a personal computer, a server, a router, a network PC, a peer device or other common network node, or any other remote media consumption or transmission device, and may include any or all of the elements described above relative to the computer 1310. The logical connections depicted in FIG. 13 include a network 1372, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system.

In addition, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described above, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating there from. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A system, comprising:
a data access component configured to obtain data represented in a first format; and
an abstraction component configured to transform a representation of the data from the first format to a second format based on a defined end result of the data, wherein the data in the first format is defined in a structured query language construct and the representation of the data in the second format is in a non-structured query language domain.

2. The system of claim 1, further comprising a query enhancement component configured to analyze the defined end result and determine a suitable format type for the representation of the data, wherein the suitable format type is determined based on efficiency or ease of implementation.

3. The system of claim 1, wherein the abstraction component is further configured to hide details related to the transform and the second format from a programmer.

4. The system of claim 1, wherein the data access component is configured to obtain the data in an input data format and a processing component is configured to transform the representation of the data from the input data format to a storage format, the storage format is independent of the input data format.

5. The system of claim 1, further comprising a conversion component configured to change a data representation to be compatible with another data representation.

6. The system of claim 1, further comprising a storage component configured to retain the representation of the data in a third format that is independent of the first format and the second format, wherein the third format is a structured query language domain or a non-structured query language domain.

7. The system of claim 1, wherein the second format is one of a table, a matrix, a tuple, a graph, or a hypergraph.

8. The system of claim 1, wherein the first format and the second format are different representations of the same data.

9. The system of claim 1, further comprising an interface component configured to receive a request for the data, the abstraction component obtains the data in a storage format and transforms the data from the storage format to a format that corresponds to the received request.

10. The system of claim 1, wherein the abstraction component is further configured to utilize structured query language constructs in non-structured query language domains.

11. A method, comprising:
obtaining data in a structured query language format;
interpreting a representation of the data;
transforming the representation of the data from the structured query language format to a non-structured query language format, wherein the non-structured query language format provides an efficiency function or a simplicity function; and
outputting the data in the non-structured query language format.

12. The method of claim 11, wherein the interpreting comprises receiving an explicit definition of a desired result, wherein the transforming is a result of the explicit definition.

13. The method of claim 11, wherein the interpreting comprises inferring a definition of a desired result as a function of one or more data inputs, wherein the transforming is based on the inferred definition.

14. The method of claim 11, wherein the structured query language format and the non-structured query language format provide equivalent results.

15. The method of claim 11, further comprises storing the data in a structured query language format or a non-structured query language.

16. The method of claim 11, wherein the obtaining comprises receiving a request for the data.

17. The method of claim 11, wherein the obtaining comprises accessing the data from a storage media.

18. A computer-readable storage medium comprising computer-executable instructions stored therein that, in response to execution, cause a computing system to perform operations, comprising:
gathering data represented in a first format; and
transforming, in real-time, a representation of the data from the first format to a second format based on a defined end result of the data, the data in the first format is defined in a structured query language construct and the representation of the data in the second format is in a non-structured query language domain, wherein the second format is selected based on an efficiency in obtaining the defined end result.

19. The computer-readable storage medium of claim 18, the operations further comprising:
hiding details of the transforming from one or more users.

20. The computer-readable storage medium of claim 18, wherein the first format and the second format are different representations of the data.
